(19) United States
(12) Patent Application Publication
(10) Pub. No.: US 2026/0138432 A1
(43) Pub. Date: May 21, 2026

(54) VEHICULAR MAGNETIC INDUCTION DEVICE, METHOD, AND SYSTEM

(71) Applicant: Jason Burt, Orlando, FL (US)

(72) Inventor: Jason Burt, Orlando, FL (US)

(21) Appl. No.: 19/048,424

(22) Filed: Feb. 7, 2025

Related U.S. Application Data
(60) Provisional application No. 63/721,636, filed on Nov. 18, 2024.

(51) Int. Cl. B60K 1/04; B60G 9/00

(52) U.S. Cl. CPC B60K 1/04; B60G 9/00; B60K 2001/0405

(57) ABSTRACT

An axle-based magnetic induction device for a vehicle, wherein the axle-based magnetic induction device provides a first portion operatively associated with an axle of the vehicle. A radial arrangement of alternating finger pole prongs project from an outer circumferential surface of the first portion. A second portion of the axle-based magnetic induction device provides a radial array of conductive coils that are radially spaced apart and offset from the arrangement of alternating finger pole prongs. The second portion is fixed to the vehicle so that a constant distance is maintained between the respective, facing distal ends of the alternating finger pole prongs and the array of conductive coils. During power transmission to the wheels, the first portion rotates with the axle relative to the fixed second portion, whereby the rotating magnetic flux of the alternating finger pole prongs relative to the fixed conductive coils generates passive energy for the vehicle.

### CROSS REFERENCE TO RELATED APPLICATION

This application claims the benefit of priority of U.S. provisional application No. 63/721,636, filed Nov. 18, 2024, the contents of which are herein incorporated by reference.

### BACKGROUND OF THE SUBJECT DISCLOSURE

The present invention relates to vehicular power generation and, more particularly, to an axle-based magnetic induction device, method and system for vehicular power generation.

The science of generating electricity by rotating a magnet near a coil of wire, which creates a changing magnetic field that induces an electric current in the wire, based on the principle of electromagnetic induction (essentially, the movement of the magnetic field across the conductor causes electrons to flow, generating electricity) is well understood. Applying operationally sound applications of that idea in the context of utilizing the rotation of a vehicle's axle as the source of magnetic rotation to produce electrical current is still fraught with challenges.

As can be seen, there is a need for an axle-based magnetic induction system for automotive power generation that creates passive power generation from the required rotational force of the vehicle's wheel axle, thereby efficiently and safely capturing the otherwise wasted energy without adding drag or resistance on the vehicle axle. The term “passive” is to be understood, in addition to its ordinary meaning, as meaning the required operation for the movement of the vehicle's wheels that can be harnessed without causing significant attenuation or interruption of said required operation.

### SUMMARY OF THE SUBJECT DISCLOSURE

The subject matter creates a new way to harness passive energy in an automobile to generate electricity to increase the generation and storage of power capabilities in hybrid and/or electric vehicles.

In one aspect of the present subject disclosure, an axle-based magnetic induction device for a vehicle includes a first portion defining an opening for operatively associating with an axle of the vehicle. An arrangement of alternating finger pole prongs projecting from an outer circumferential surface of the first portion. A second portion of the axle-based magnetic induction device is arranged radially outward of the first portion and has a plurality of spindles of conductive coils arranged along an inner circumferential surface of the second portion. The second portion is configured so that an air gap persists between an outermost extent of the arrangement of alternating finger pole prongs and an innermost extent of the plurality of spindles, whereby rotation of the axle causes, by way of the arrangement of alternating finger pole prongs, a rotating magnetic flux relative to the plurality of spindles.

In another embodiment of the present invention, the axle-based magnetic induction device may further include wherein the air gap is no greater than five millimeters, wherein the second portion is semi-circular and located upward of the axle, and wherein an attachment enclosure that is rigid and non-metallic, wherein the attachment enclosure has a periphery that accommodates the first and second portions and supports the second portion relative to the first portion while maintaining the air gap

These and other features, aspects and advantages of the present subject disclosure will become better understood with reference to the following drawings, description and claims.

### BRIEF DESCRIPTION OF THE DRAWINGS

FIG. 1A is a perspective view of an exemplary embodiment of a subject disclosure operatively associated with a vehicular axle 50.

FIG. 1B is a detailed perspective view of an exemplary embodiment of the present invention taken along line 1B in FIG. 1A.

FIG. 2 is an enlarged view of FIG. 1B.

FIG. 3 is a detailed perspective view of FIG. 2.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

A general overview of the various features of the invention will be provided, with a detailed description following. Broadly, an embodiment of the present invention provides an axle-based magnetic induction apparatus for the passive generation of vehicular electricity.

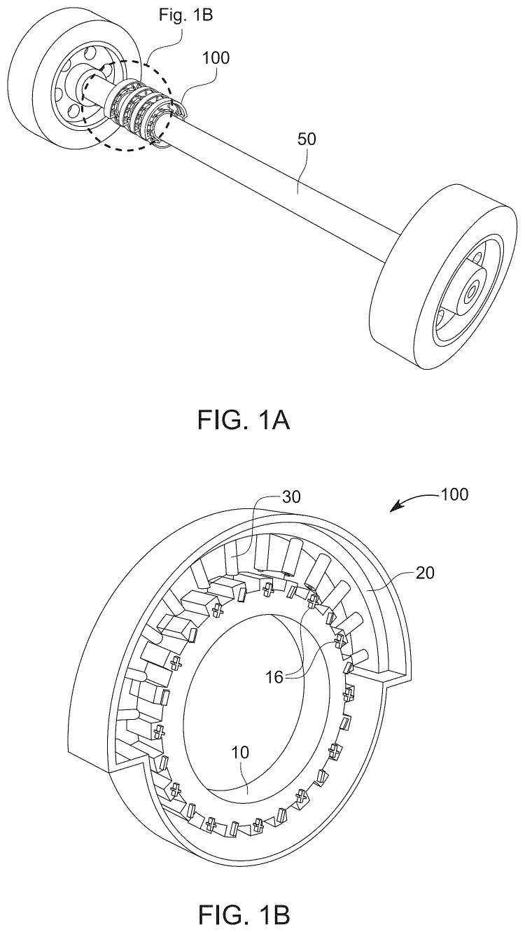

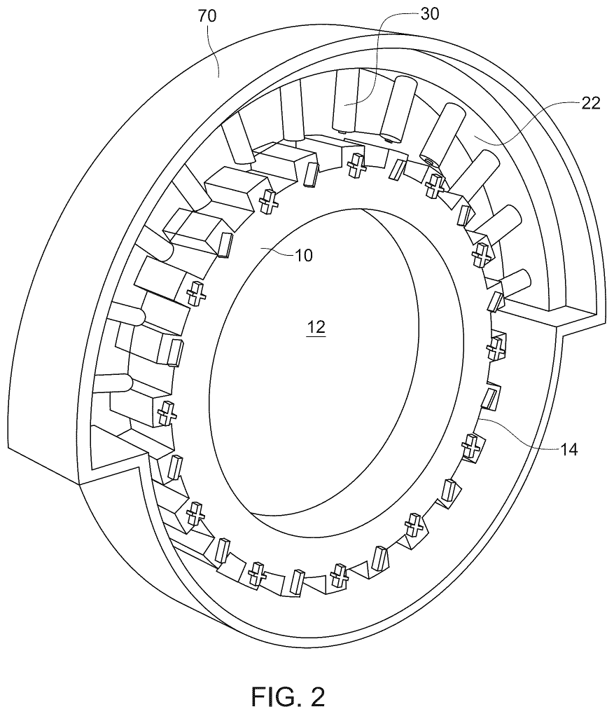

Referring now to FIGS. 1A through 3, the present invention may include a axle-based magnetic induction system configured to leverage the rotation of a vehicle's axle 50 to generate electricity through induction.

The axle-based magnetic induction system may include a plurality of axle-based magnetic induction devices 100, wherein each device 100 has a first portion 10 and a second portion 20 that work in concert. The first portion 10 operatively is associated with the axle 50 so they both rotated in unison. The first portion 10 may provide be arcuate shaped and provide opening 12 through which the axle 50 is received and operatively associated with the axle-based magnetic induction device 100.

Along an outer circumferential surface 14 of the first portion 10 are alternating finger pole prongs 16. Each pole prong 16 has either a North or South magnetized pole, and the finger pole prongs 16 are alternatingly arranged in a radial array relative to the center of the axle 50 it operatively associates with. In embodiments, where an opening 12 is used to operatively associate with the axle 50, the finger pole prongs 16 are radially arranged uniformly relative to the center of that opening 12. Accordingly, each finger pole prong 16 provides a discrete outward facing electromagnetic pole, where each prong 16 is a magnetized pole. Thus, when the plurality of alternating finger pole prongs 16 rotate - in concert with the rotation of axle 50 that the axle-based magnetic induction device 100 is operatively associated with-a rotating magnetic flux is formed.

The second portion 20 of the axle-based magnetic induction device 100 is located radially outward of the first portion 10. The second portion 20 is fixed to the frame, body, or chassis of the vehicle, but not the axle 50, thereby while the first portion 10 rotates with the axle 50, the second portion 20 is rotationally fixed relative to the first portion 10.

Spaced apart along an inner circumferential surface 22 of the second portion 20 are a plurality of conductive coil elements 30, which may be housed in cylindrical spindles (though other housing, supportive structure, and shapes are contemplated by the subject disclosure). Each spindle of coil element 30 may provide conductive coiled wire or windings of conductive material cable (copper, aluminum, etc.) that are wound around a conductive pin, up to one thousand or more rotations. In some embodiments, each spindle of coil 30 may include enameled copper coil.

The arrangement of conductive coils element 30 along the inner circumferential surface 22 defines a radial array, wherein each conductive coil element 30 extends radially inward toward the first portion 10. The distal end of each conductive coil element 30 faces the first portion 10. The second portion 20 is fixed to the vehicle so that a constant distance 75 is maintained between the (inward facing) distal ends of the conductive coil elements 30 and the (outward facing) distal ends of the finger pole prongs 16. This distance may be referred to as an air gap 75.

In some embodiments, the second portion 20 is semi-circular and so the second portion 20 is adjacent to only approximately half (or one radian of) the outer circumferential surface 14 of the first portion 10. For instance, the second portion is disposed along an “upper” portion of the first portion 10 (where “upper” relative to the axle or supporting surface of the vehicle). Due to operation of the vehicle, the lower half of the axle-based magnetic induction devices 100 needs to have a low profile to avoid issues with clearance below the vehicle. Though in some embodiments, the second portion 20 may be fully circular through smaller components of same number of windings and quantity of magnetic power, as it could be better to be fully surrounding.

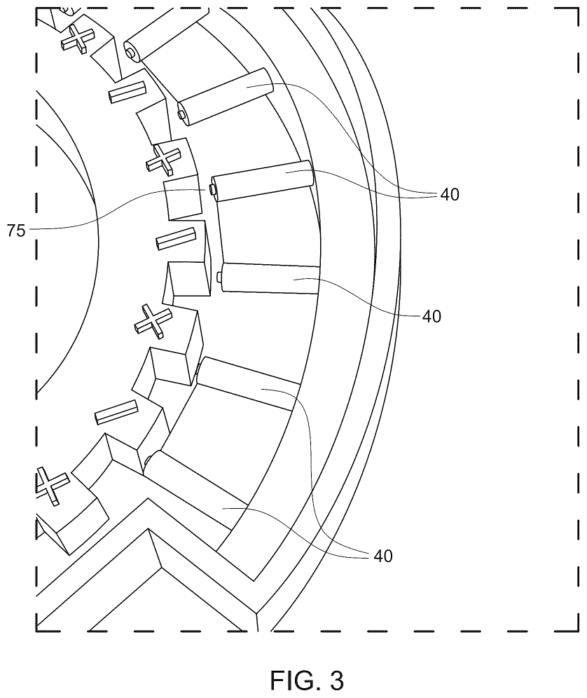

Referring to FIG. 3, the spindles 30 are wired via electrical connections 40 with each other, typically top to top, then bottom to bottom. The ends and beginnings of the electrical connections 40 are electrically coupled to a battery apparatus (not shown) for storing electrical power generated by the magnetic flux imparted by the rotating plurality of finger pole prongs 16, through charging the battery apparatus. The battery apparatus may be the existing battery in the hybrid/electric vehicle, or, if the resulting voltage does not match up, it could be its own battery to store and retrieve the energy. The battery apparatus does not take part in electrical induction, only storage of the energy.

A strut (not shown), armature, kicker or the like may be used to form a fixed connection between the second portion 20 and the vehicle. The subject disclosure envisions any sufficiently rigid connection, unitary or otherwise, that facilitates the rotationally fixed relationship between the second portion 20 relative to the first portion 10. This stationary support needs to be sufficient to not “slip” (and thus fail to maintain the air gap 75) when the axle 50 rotates to convey power from the engine to the wheels.

Each axle-based magnetic induction device 100 may provide an attachment enclosure 70 that is rigid and non-metallic. The attachment enclosure 70 may be annular or the like to circumscribe and track the outermost extent of both the first portion 10 and the second portion 20. An outer circumferential surface of the second portion 20 may be fixed to the attachment enclosure 70. Thus, the attachment enclosure 70 may be fixed to the vehicle, which as a result fixes the second portion 20 to the vehicle, while the attachment enclosure 70 acts as a guard for the first portion 100, which it circumscribes as shown in the illustrations.

The attachment enclosure 70 may be configured to support the second portion 20 relative to the first portion 10 so that the air gap 75 between the inward ends of the spindles 30 relative to the outward ends of the finger pole prongs 16 is constantly maintained during operation of the vehicle. The air gap 75 between the finger pole prongs 16 and the spindles 30 may be mere millimeters but facilitate the axle-based rotation of the first portion 10 relative to the fixed second portion 20 without adding drag or resistance on the vehicle axle 50. Put another way, the air gap 75 clarifies that the conductive coil elements 30 and the magnetic finger pole prongs 16 do not touch and so do not cause drag. The conductive coil elements 30 must be within the magnetic field, so they must be close enough (or have an “effective distance”) during the dynamic conditions of the vehicle axle 50 to work successfully.

The strength of the magnets underlying the finger pole prongs 16 can be adjusted to optimize the output. Increasing the quantity of axle-based magnetic induction device 100 operatively associated with the axle 50 would increase the output by multiplying the lines of flux passing the coil therefore increasing the electrical current. Similarly, the number of rotations of the copper cable/coil in each spindle or conductive coil element 30 can be increased, since the more turns that can be achieved within the magnetic field will increase the electrical current.

The subject disclosure is a novel and non-obvious application of basic physical law of magnetic induction to the automotive industry. Arranging and securing the magnets to the axle 50, that through normal vehicular operation will rotate the magnet near the fixed conductive coil elements 30, which are configured to receive the movement of magnetic lines of flux from the magnets and so will result in the movement of electrons (electric voltage) sufficient to send additional charge to an existing electrical storage device (battery).

The intent is that the finger pole prongs 16 stay fixed to the first portion 10 but rotate with the axel 50 so that the conductive coils 30 experience the rotating magnetic flux that induces electricity.

The subject disclosure utilizes the arrangement of the axle-based magnetic induction devices 100 to take advantage of wasted energy that is necessary to convey a vehicle. The subject disclosure can be utilized to further augment the stored energy in hybrid and/or electric vehicles and could be utilized for various other electrical needs of a standard gasoline vehicle.

The application of this innovation is configured to augment the generation of electricity through magnetic induction is new and not in use in the automotive industry presently. Believe this will support enhanced capacity in distance capabilities because it is adding power from a passive source.

Alternatives would include increasing the magnetic power with focus on size/weight, adjusting the gear system to maximize efficiency and the number rotations of the magnetic field over the copper coils. Alternatives also include the number and strength of batteries utilized and the number of apparatuses on a given axle. Further development could also be to attach magnets directly to the axel and copper coils above so that the magnets pass the axes of the coils in normal rotation. Furthermore, any existing rotating shaft or rotational prime mover that is already designed to be in motion by functional necessity would be capable of utilizing this configuration to generate electricity. One specific example of this use is the fans utilized for air conditioning systems.

This subject disclosure could be utilized on existing vehicles and could be utilized in the design of new vehicles. Designing or attaching the gear system to the vehicles' axle in a configuration to rotate the magnets over in the identified proximity to the copper coil without adding friction or without adding significant load on the axle enabling a power source of greater than on volt (“1V”). This voltage would be greater at higher velocity and gearing of the rotation motion to improve the number of turns of the magnetic field adjacent to the copper coils. Specific key elements include the coils being wired in circuits to generate the alternating current and the proximity of the magnet being as close as feasible to the coil elements 30 (as noted in terms of the air gap 75) and strength of the magnet amplifying the magnetic fields. Additionally, this induction apparatus 100 can be applied in more than one location on the axle 50 of a vehicle resulting in additive output in the same vehicle.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. An axle-based magnetic induction device for a vehicle having an axle, the axle-based magnetic induction device comprising:
a first portion operatively associated with said axle;
an arrangement of alternating finger pole prongs projecting radially outward from an outer circumferential surface of the first portion; and
a second portion arranged radially outward of the first portion, wherein the second portion is rotationally fixed relative to the first portion; and
a plurality of coil elements arranged along an inner circumferential surface of the second portion, wherein the plurality of coil elements extend radially inward toward the first portion;
whereby rotation of the axle causes, by way of the arrangement of alternating finger pole prongs, a rotating magnetic flux relative to the plurality of coil elements.

2. The axle-based magnetic induction device of claim 1, further comprising an air gap between an outermost extent of the arrangement of alternating finger pole prongs and an innermost extent of the plurality of coil elements.

3. The axle-based magnetic induction device of claim 2, wherein the air gap is no greater than five millimeters.

4. The axle-based magnetic induction device of claim 3, wherein the second portion is semi-circular and located upward of the axle.

5. The axle-based magnetic induction device of claim 4, further comprising an attachment enclosure that is unitary with the vehicle and the second portion, wherein the attachment enclosure has a periphery that circumscribes the first portion and the second portion.

6. The axle-based magnetic induction device of claim 5, wherein each coil element is housed in a spindle.

7. The axle-based magnetic induction device of claim 6, wherein the first portion provides an opening for operatively associating with the axle.
